(19) United States
(12) Patent Application Publication
(10) Pub. No.: US 2022/0323803 A1
(43) Pub. Date: Oct. 13, 2022

(54) Helicopter Tank

(71) Applicant: Blackhawk Mission Equipment, LLC, Leesburg, FL (US)

(72) Inventors: Bart Brainerd, Leesburg, FL (US); Kenny Brown, Leesburg, FL (US)

(21) Appl. No.: 17/658,434

(22) Filed: Apr. 7, 2022

Related U.S. Application Data
(60) Provisional application No. 63/171,985, filed on Apr. 7, 2021.

(51) Int. Cl. A62C 3/02; B64D 1/16

(52) U.S. Cl. CPC A62C 3/0235; B64D 1/16

(57) ABSTRACT

An intake, storage, and distribution system for providing firefighting and liquid disbursement intake and distribution to a helicopter. The tank is constructed to slide or be positioned into a passenger compartment of a helicopter. In a preferred embodiment, the water tank has an external snorkel hose equipped with a pump for loading of the water into the tank. The snorkel hose is preferably configured to be connected to the frame of the aircraft to support the weight of the snorkel. This is of assistance, for example, when a helicopter is hovering above a liquid source and uptaking liquid through the snorkel hose or tube.

### TECHNICAL FIELD

The disclosure generally relates to the field of aerial firefighting. Particular embodiments relate to a helicopter having an internal tank for holding a liquid and a snorkel for filling the tank and dispelling fluid from the tank.

### BACKGROUND

Aerial firefighting is the use of aircraft to combat wildfires. The types of aircraft used include fixed-wing airplanes and helicopters. Aircraft generally combat the wildfires by dropping water, water enhancers such as foam or gel, or specially formulated fire retardants.

The BHI H60 UH-60A, UH-60L (UH-60A/L) and S-70, S-70A, S-70C (S-70A/C) (collectively “the helicopters”) are type certificated restricted category helicopters used for aerial dispensing of liquids (firefighting) and external load operations. The crew on board consist of two crew members (pilot and co-pilot) during mission operations, and up to three crew members ((2) pilots & (1) mechanic) during “in-transit” to reach base of operations or returning to home base. What is needed is an improved mechanism for loading, carrying, and dispensing fluid for firefighting in a helicopter.

### SUMMARY OF INVENTION

The purpose of the Summary of Disclosure is to enable the public, and especially the scientists, engineers, and practitioners in the art who are not familiar with patent or legal terms or phraseology, to determine quickly from a cursory inspection, the nature and essence of the technical disclosure of the application. The Summary of the Invention is neither intended to define the invention of the application, which is measured by the claims, nor is it intended to be limiting as to the scope of the invention in any way.

What is disclosed is an internal water tank and snorkel configured for installation in the main cabin of a helicopter. The water tank is configured to be installed in various aircraft models, including but not limited to: UH-60A, UH-60L, S-70, S-70A, S-70C. These models share same airframe, flight & powerplant controls and limitations. In alternate embodiments, the water tank is configured to install in the main cabin of various different aircraft with lateral openings in the fuselage.

In a preferred embodiment, the water tank is installed such that the snorkel and part of the water tank extends through one of the helicopter side doors. The water tank is configured such that the snorkel can extend through either the left or right-side door of the helicopter. The water tank is configured to be modular and is preferably not integrated with the gate system (the drop doors in the bottom of firefighting helicopters used to drop liquids).

In another embodiment, at least a portion of the water tank is configured to extend out at least one of the aircraft side doors. In this embodiment, the water tank is configured to release water through the aircraft side door.

In another embodiment, the water tank can release water through the gate system and out the side door.

The water tank is normally filled with water to combat fires, but per contract with the US Forest Service (USFS), the water tank should have the ability to fill water with a powder-based fire-retardant material if requested. For the purpose of this project we will refer to the tank as the “water tank” understanding that can carry water with fire retardant material also. (Specimen coupons will be conditioned using water with retardant for flammability and structural testing).

### BRIEF DESCRIPTION OF THE DRAWINGS

FIG. 1a is a front sectional perspective view of an embodiment of an internal water tank.

FIG. 1b is a front sectional view of an embodiment of an internal water tank.

FIG. 1c is a front sectional view of an embodiment of an internal water tank.

FIG. 2 is a side view of an embodiment of the helicopter with an internal water tank installed.

FIG. 3 front cross sectional view of the main cabin of the aircraft.

FIG. 4 is a top cross sectional view of the upper restraint system.

FIG. 5 is a top cross sectional view of the lower (floor) restraint system.

FIG. 6 is a perspective view of an embodiment of the data vault and message interface installed in the cockpit center console.

FIG. 7 is an embodiment of the cockpit water tank control switch panel.

FIG. 8 is the electrical function system of the water tank control system.

FIG. 9 is an embodiment of a helicopter with an internal water tank and snorkel hose and pump.

FIG. 10 is a side perspective view snorkel hose and pump used for the internal water tank.

FIG. 11 is a top view of a 7.5 horse power pump used for the internal water tank.

FIG. 12 is side perspective view an embodiment of a helicopter with an internal water tank in a hover collecting water.

FIG. 13 is an illustration of a cargo area in a UH-60 and S-70 series aircraft.

FIG. 14 is a rear side perspective view of an embodiment of the water tank.

FIG. 15 is a front side perspective view of an embodiment of the water tank.

FIG. 16 is a front side perspective view of a helicopter with an embodiment of the water tank installed.

### DISCLOSURE

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

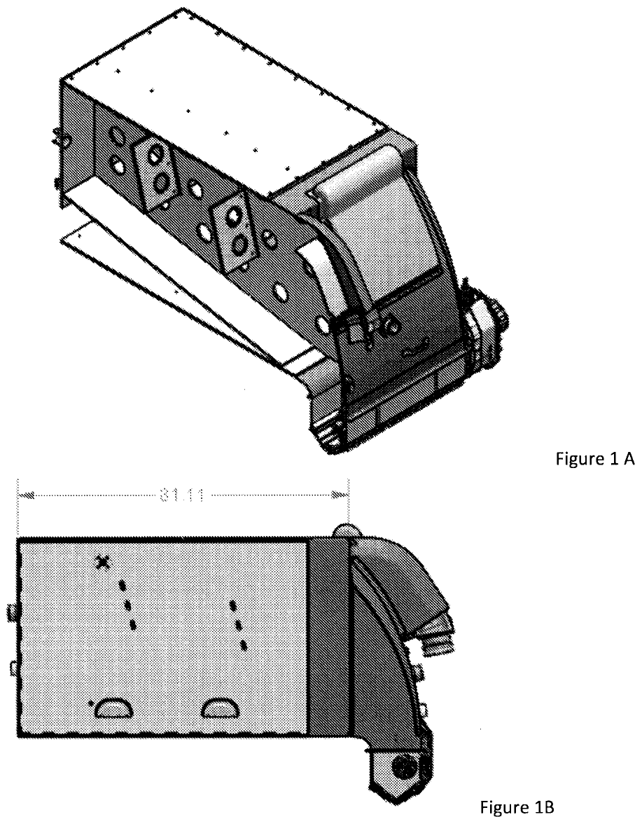

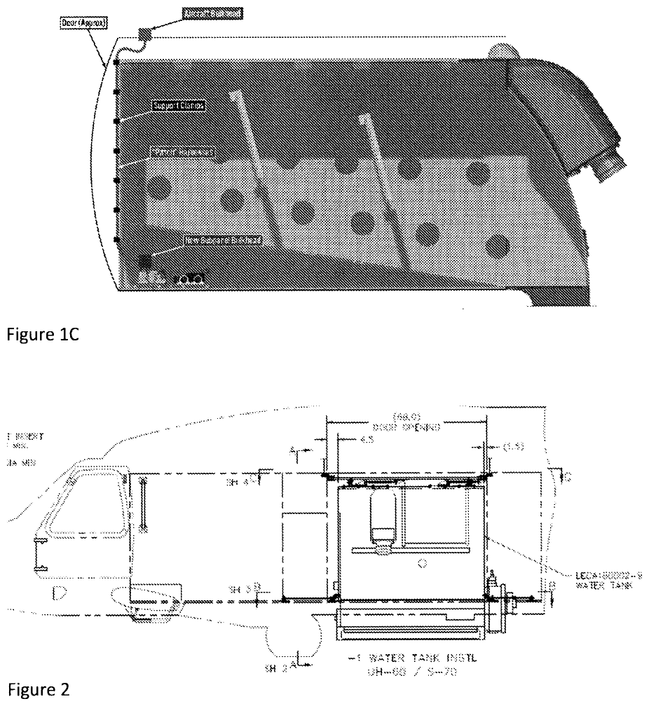

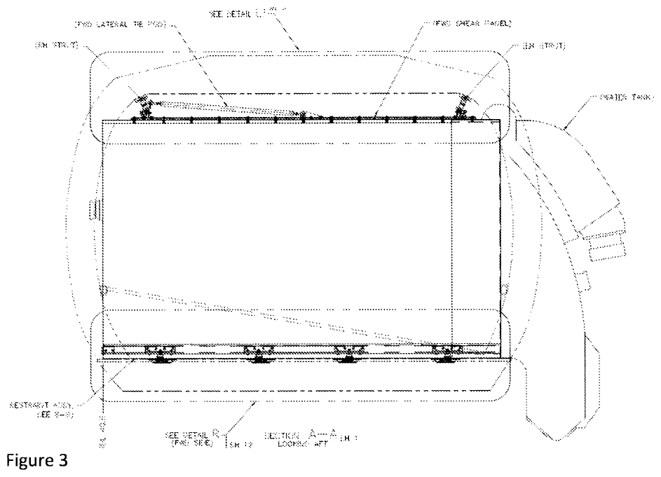

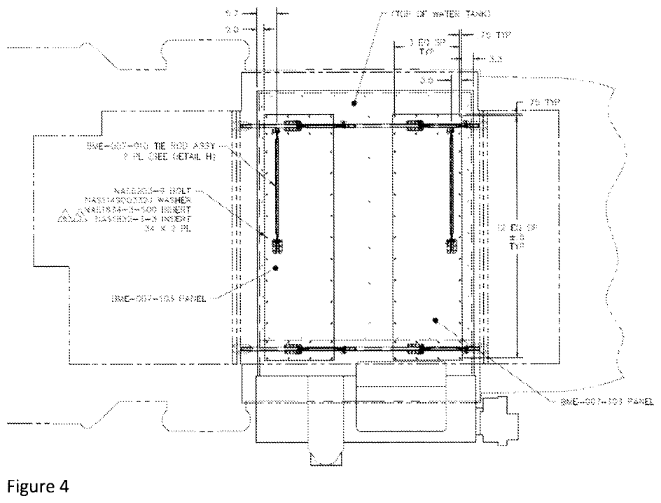

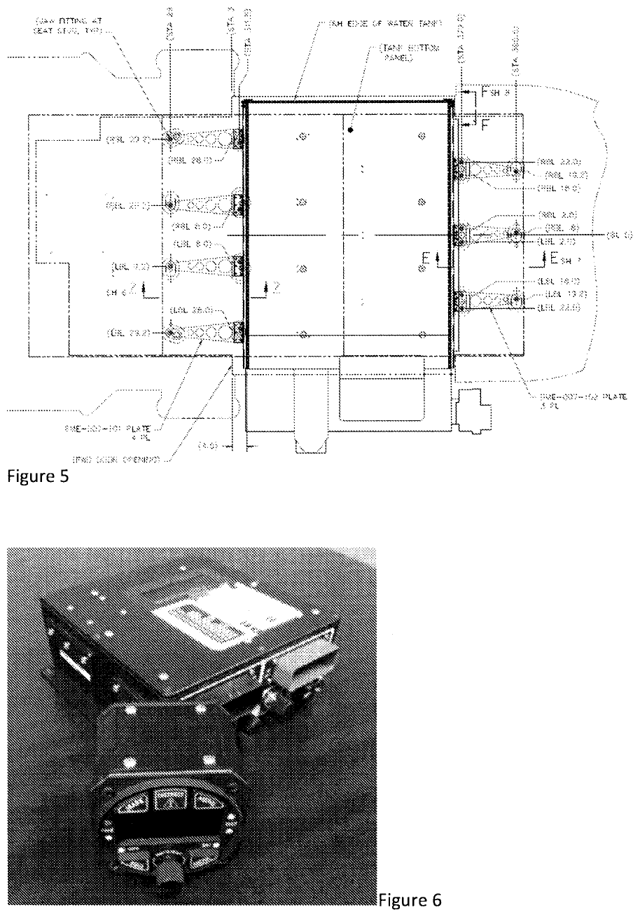

FIGS. 1a-c depict an embodiment of the internal water tank. In a preferred embodiment, a helicopter will have a 925-gallon internal water tank & snorkel in the main cabin, (STA.288 thru 398, WL206, L/R BL 0-42) and is preferably removable. The installation is preferably applicable to the following aircraft models: UH-60A, UH-60L, S-70, S-70A, S-70C. These models share same airframe, flight & powerplant controls and limitations. In a preferred embodiment, a helicopter is retrofitted so that an internal water tank can be installed. In alternative embodiments, the internal water tank can be installed in different models of aircraft and at different volumes.

In a preferred embodiment, the water tank is fabricated using carbon fiber for durability and weight savings. Alternate embodiments of the water tank can be constructed from other lightweight materials known in the art. The water tank full of water does not exceed the aircraft maximum weight and does not exceed the aircraft CG. The tank preferably has an angled subfloor for a gravity fed water drop, and a triple redundancy means for water drop, toggle switch in flight controls, control switch panel in center console and mechanical cable handle on left hand side of the center console, also known as the emergency dump (E-dump).

In a preferred embodiment, the water tank has an external snorkel hose equipped with a pump for loading of the water into the tank. The tank preferably can also be loaded on the ground thru a 6″ diameter water hose nozzle. The water tank preferably has an electric geared gate door, powered by an independent, 24-volt sealed lead acid TSO aircraft battery P/N RG24-15 located underneath the water tank. The right or left side doors can either be opened or removed when the water tank is installed. Removal and/or opening of the doors allows for the external snorkel hose to extend out the right or left side of the helicopter.

FIG. 2 depicts an embodiment of an internal water tank install restraint layout. In a preferred embodiment, the installation includes an upper and lower restraint system with minimal modification to the aircraft airframe, utilizing existing tie down locations in the main cabin between aircraft.

In a preferred embodiment, the upper restraint system includes the installation of a cross bar attached to the upper (L/R) forward and aft cargo ring points (existing cargo rings are removed for this application). The cross bar preferably has multiple brackets and struts with elastomeric bearings that attach to the internal water tank lid. There are preferably lower restraint machined brackets that attached to existing floor tie downs and to an existing rail on the tank. The internal water tank restraint system is preferably designed to meet compliance with 14 CFR Part 29.561 Amendment 29-0 for crash loads full or empty tank: 1.5 g Upward, 4.0 g Forward, 2,0 g Sideward, 4.0 g Downward.

In a preferred embodiment, the aircraft main cabin cargo loading capacity is 8,370 lbs between aircraft STA. 288 thru 398, L/R BL 0-42, WL 206. The total weight for the installation with preferably 925 gallons of water is 8,368.5. Total fuel onboard may be limited by the total weight of the crew, water tank installation and the total water onboard. Initial weight and balance calculations show a CG limit at 360.2, well within the CG range of the aircraft.

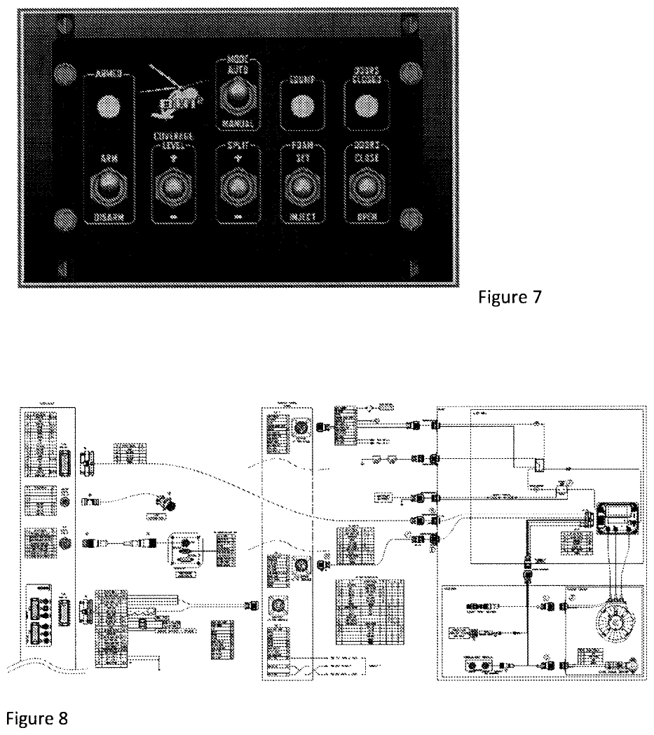

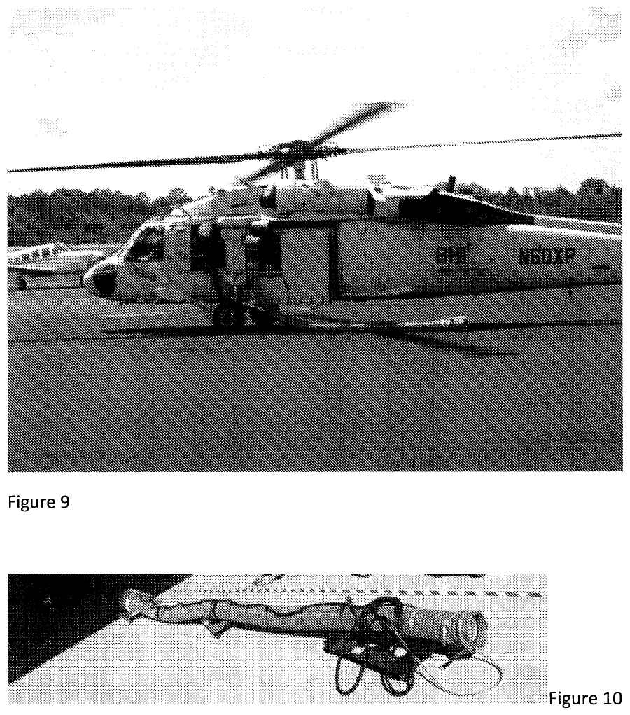

In a preferred embodiment, the internal water tank install is controlled with a Trotter Controls, “Data Vault,” depicted in FIG. 6, and switch panel located in the cockpit center console, depicted in FIG. 7. Associated equipment preferably involves a motor controller located in a dry compartment in the water tank subfloor, a telemetry box located in the nose compartment, and an external Iridium antenna installed on the upper tail section of the aircraft in support of the telemetry box.

In a preferred embodiment, the electrical system for the water tank is powered by the #2 DC and AC bus circuit breaker panel. A sealed lead acid battery preferably located in a dry compartment in the water tank subfloor, powers the gate doors and it is re-charged using the #2 AC bus. Routing of the electrical harnesses is preferably routed so there will be no EMI or EMC interference with any of the aircraft electrical system.

In a preferred embodiment, the Data Vault, message interface and motor controller are non-essential equipment. Failure of these components will not result in an unsafe condition in the aircraft and failure of any of these components will only result in the pilot dumping the water and returning to air base for system ground maintenance.

In a preferred embodiment, the DataVault is in the nose compartment. This box performs telemetry and tank system control functions.

In a preferred embodiment, the Message Interface and Switch Panel in the cockpit. The Message Interface is the display unit for the DataVault, and the Switch Panel controls mode of operation for the tank.

In a preferred embodiment, the Motor controller, relay and circuit breaker under the tank. This controller processes commands from the DataVault to control the electric motor.

FIGS. 10 depicts an embodiment of a helicopter with an embodiment of the snorkel hose and pump attached to the helicopter.

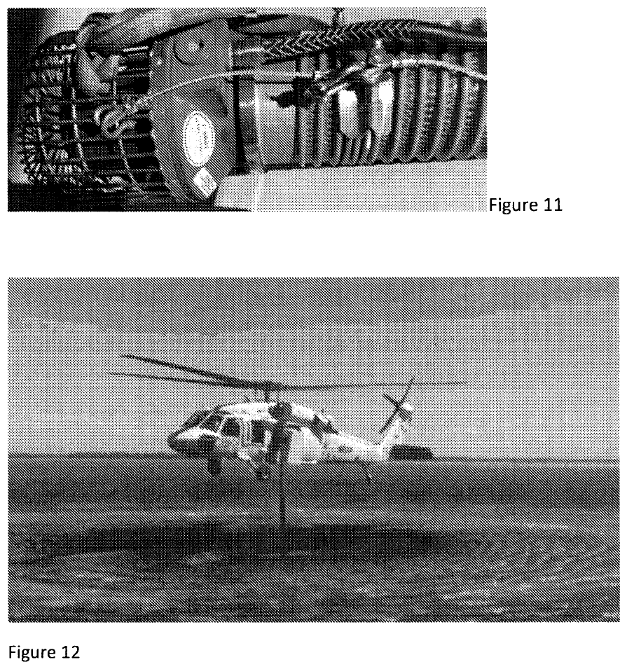

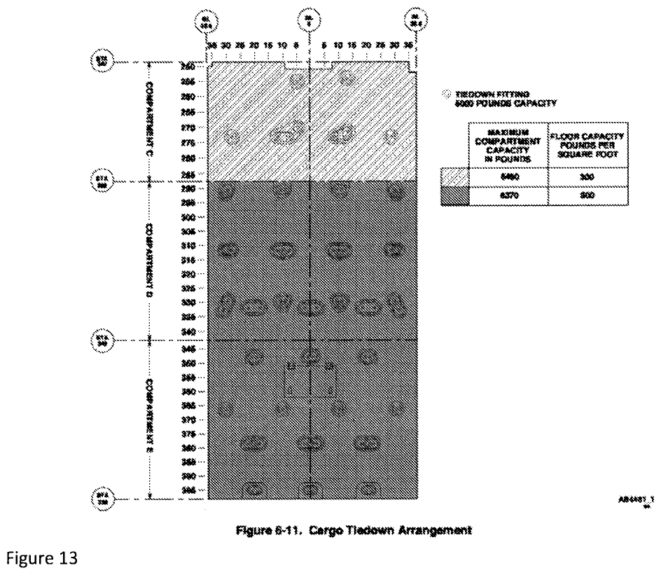

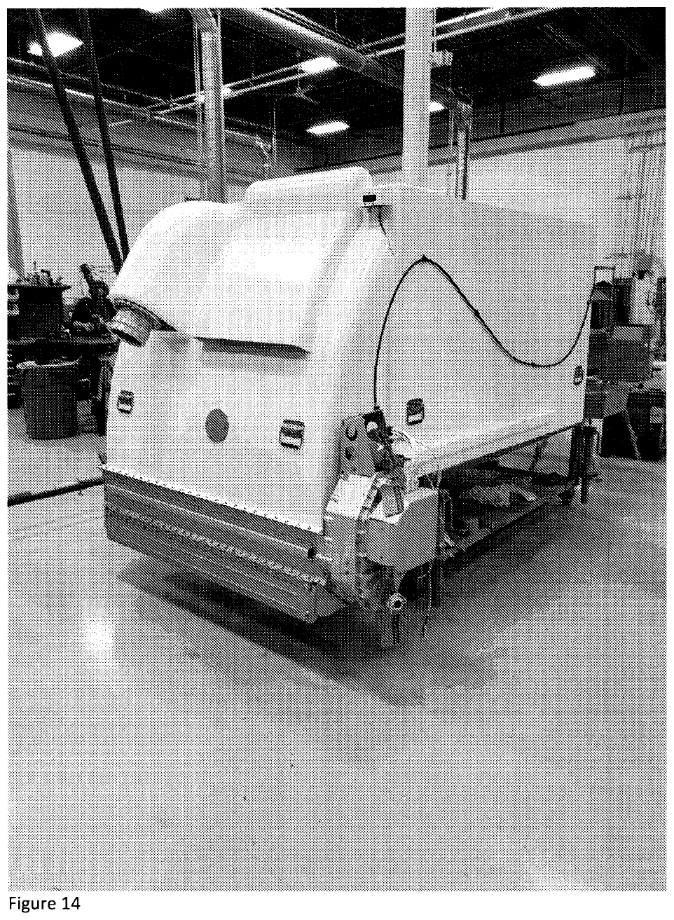

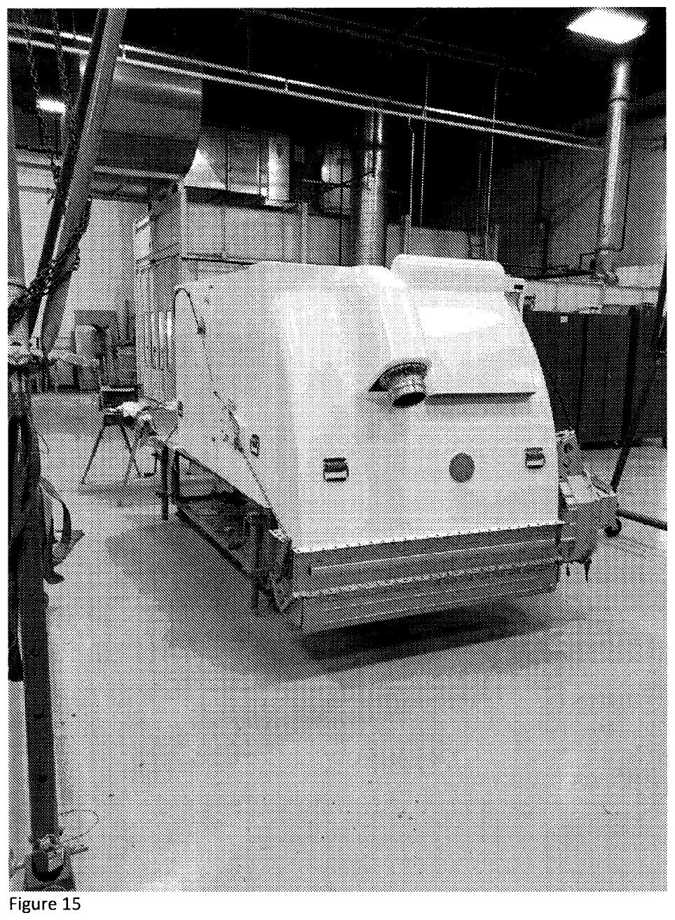

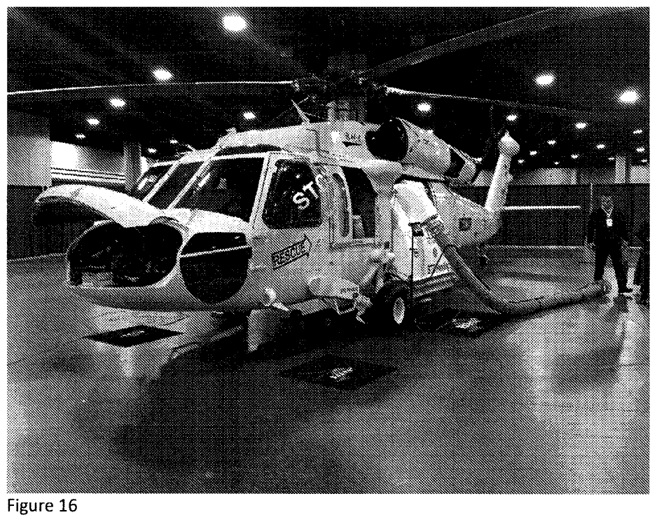

FIGS. 11 and 12 depict the snorkel hose and pump. In a preferred embodiment, the snorkel hose and pump include 15 feet, 6-inch diameter hose (manufactured by Plastixs Manufacturing Solutions). Preferably, a 7.5 hp Carry Manufacturing, Inc. pump P/N S1-6075-325-1A, generates 6.42 psi in this application. The pump fills up the tank to capacity in 55 seconds.

In a preferred embodiment, the pump and hose are attached using Carry Manufacturing, Inc. clamping system (pump to hose and hose to tank). The wire harness is preferably a three phase 115 volts AC harness, connected to 40-amp RCCB to supply power to the pump motor, and grounded to the aircraft, this is coming from the #2 AC primary bus of the aircraft. The harness is preferably 25 feet long and it is secured to the hose with nylon zip-ties.

In a preferred embodiment, the hose is attached to the water tank nozzle with a 6-inch camlock coupling. Water tank overfill is prevented by monitoring the message interface display for tank water quantity and engine torque gauge limits. In the case of a water tank overfill an overflow is preferably located on the left side of the tank to automatically discharges excess water.

When the water tank is installed in the aircraft, the emergency exits available always are the cockpit crew doors left and right and gunner windows exit left and right. These emergency exits are identified as such by the existing flight manual.

Preferably the intake hose or snorkel is connected to the frame of the aircraft. The tank is connected by a transfer tube that fluidly connects the uptake tube to the storage tank. The uptake tube is preferably connected to the frame of the aircraft such that the weight of the uptake tube is supported by the frame of the aircraft, as opposed to the storage tank. The transfer tube can be an extension of the uptake tube from the connection to the aircraft frame, or alternatively can be affixed to the uptake tube and extend to a port to the transfer tank.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

I claim:

1. A water tank for aerial dispensing of liquids comprising;
a water tank, wherein said tank is configured for installation into an internal cabin of a helicopter;
a pump, said pump attaching a snorkel hose, wherein said pump and said snorkel hose are configured for filling said tank when said helicopter is aerial;
wherein said tank is configured for unloading water from said helicopter when said helicopter is aerial.

2. The water tank of claim 1, wherein said snorkel hose is configured to extend outside the body of said helicopter.

3. The water tank of claim 2, wherein said water tank is configured to extend outside the body of said helicopter, wherein said water tank is configured to release water through a side door in said helicopter.

4. The water tank of claim 1 wherein said water tank has a volume of 925 gallons.

5. The water tank of claim 1 wherein said water tank further comprises an upper restraint and a lower restraint system configured for restraining said water tank in said helicopter.

6. The water tank of claim 1 wherein said water tank is a carbon fiber material.

7. The water tank of claim 1, wherein said water tank is modular.

8. The water tank of claim 1, wherein said water tank and said pump are operated by an internal control system in said helicopter, said control system being configured for filling said water tank when said helicopter is aerial and said control system being configured for dispensing said water from said water tank and said helicopter when said helicopter is aerial.
